(19) United States
(12) Patent Application Publication
(10) Pub. No.: US 2007/0246454 A1
(43) Pub. Date: Oct. 25, 2007

(54) Oven with two optional ranges of temperature

(76) Inventor: Ching-Hsiang Wang, Tainan City (TW)

Correspondence Address: Ching-Hsiang Wang, P.O. BOX 90, Tainan City, 70499, TW

(21) Appl. No.: 11/407,222

(22) Filed: Apr. 20, 2006

(51) Int. Cl. F27D 11/00

(52) U.S. Cl. 219/441

(57) ABSTRACT

An oven with two optional ranges of temperature includes an outer body, an inner body, a baking pan and a cover. The outer body has a temperature controller and a switch that are mutually connected by a switch line. The switch has a high-temperature line and a low-temperature line at the other side. The inner body fixed in the outer body has an electro thermal pad wrapped around its exterior wall, connected with the electro thermal pad line, the high-temperature line and the low-temperature line. The baking pan is put in the inner body and covered by the cover. Therefore, via handling properly the temperature controller and the switch, the present invention can be used to bake or stew foods.

### BACKGROUND OF THE INVENTION

1. Field of the Invention

This invention relates to an oven, particularly to one having two optional ranges of temperature so that it can be used to bake or stew foods, and even for warming foods.

2. Description of the Prior Art

Nowadays, suppose a chicken is to be baked, it is commonly done in a conventional oven, just setting a necessary time and temperature. But, because the interior of the oven and the baking plate carrying the chicken are always very hot when the time is up, a user has to wear very thick heat-proof gloves to take the plate out of the oven, possible to get scalded in case of carelessness. In addition, such a conventional oven can do nothing but baking. Therefore, the invention has been revised to overcome the defects mentioned above.

### SUMMARY OF THE INVENTION

The objective of this invention is to offer an oven with two optional ranges of temperature, able to bake, to stew or to warm foods.

The main characteristics of the invention are an outer body, an inner body, a baking pan and a cover. The outer body is provided with a temperature controller and a switch. The temperature controller is connected with a power line, an electro thermal pad line at one side, a switch line the other side and a temperature knob set on the exterior surface. The switch connected with the switch line of the temperature controller at one side is provided with a high-temperature line and a low-temperature line at the other side and a switching knob on an exterior preset position. The inner body fixed in the outer body is provided with an electro thermal pad wrapped around its exterior wall, connected with the electro thermal pad line of the temperature controller, the high-temperature line and the low-temperature line of the switch. The baking pan put in the inner body is provided with a grip projecting from two sides respectively for resting on the inner body and a baking tray. The cover is to be covered on the baking pan.

### BRIEF DESCRIPTION OF DRAWINGS

This invention is better understood by referring to the accompanying drawings, wherein:

FIG. 1 is an exploded perspective view of a preferred embodiment of an oven with two optional ranges of temperature in the present invention;

FIG. 2 is a perspective view of the preferred embodiment of an oven with two optional ranges of temperature in the present invention; and

FIG. 3 is a circuit diagram of the present invention.

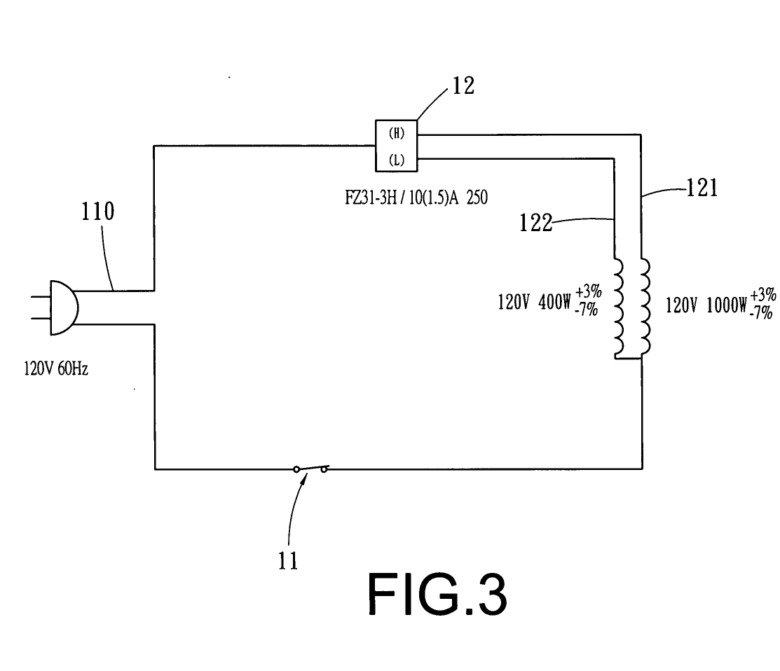

### DETAILED DESCRIPTION OF THE PREFERRED EMBODIMENT

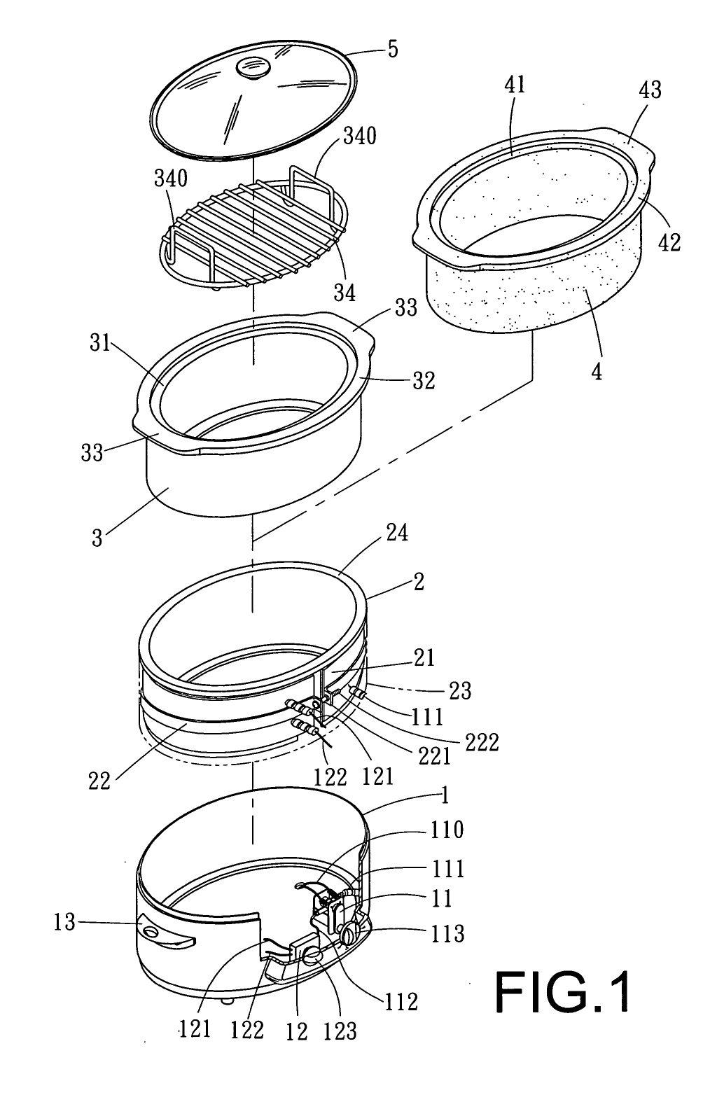

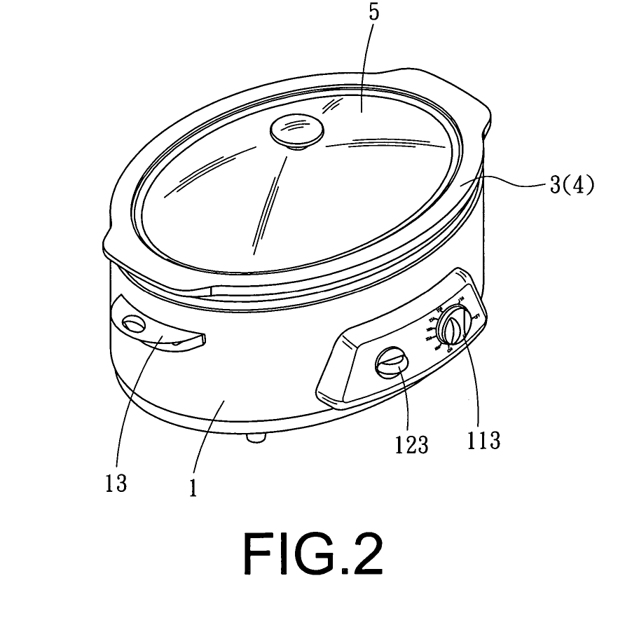

As shown in FIGS. 1 and 2, a preferred embodiment of an oven in the present invention includes an outer body 1, an inner body 2, a baking pan 3, a ceramic pan 4 and a cover 5 as main components.

The outer body 1 is provided with a temperature controller 11 and a change-over switch 12 at the front side and two grips 13 at its two sides. The temperature controller 11 is connected with a power line 110, an electro thermal pad line 111 at one side, a switch line 112 at the other side and a temperature knob 113 set on the exterior surface. The switch 12 is connected with the switch line 112 of temperature controller 11 at one side, with a high-temperature line 121 and a low-temperature line 122 at the other side, having a switching knob 123 on an exterior surface.

The inner body 2 fixed in the outer body 1 is provided with an electro thermal pad 21 wrapped around its exterior wall, connected with the electro thermal pad line 111 of the temperature controller 11, the high-temperature line 121 and the low-temperature line 122 of the switch 12, a positioning member 22 fitted around the exterior surface of the electro thermal pad 21 and having a L-shaped connecting end 221 at its two ends respectively for a screw 222 to combine the two L-shaped connecting ends together fixedly, a thermal isolator 23 made of heat-resistant material wrapped around the electro thermal pad 21. The inner body 2 further has a supporting edge 24 on its annular top edge.

The baking pan 3 put in the inner body 2 is provided with a covering rim 31 on the top, an extended rim 32 extending outwards around the top edge for resting on the supporting edge 24 of the inner body 2, a grip 33 projecting from two sides of the 32 respectively and a baking tray 34 provided with a holder 340 at its two sides respectively for containing foods, such as a chicken.

The ceramic pan 4, an alternative of the baking pan 3 put also in the inner body 2, is provided with a covering rim 41 on the top, an extended rim 42 extending outwards around the top edge for resting on the supporting edge 24 of the inner body 2 and a grip 43 projecting from two sides of the extended rim 42 respectively.

The cover 5 is to be covered on the baking pan 3 or the ceramic pan 4.

In using, as shown in FIGS. 1˜3, if a chicken is to be baked, put the baking pan 3 in the inner body 2 first, the baking tray 34 in the baking pan 3, the chicken on the baking tray 34 and the cover 5 on the baking pan 3 orderly. Next, turn the switching knob 123 of the change-over switch 12 to the position of the high-temperature line 121 and then, turn the temperature knob 113 of the temperature controller 11 to select a proper baking temperature. Then, the oven can start to bake. When the electro thermal pad 21 of the inner body 2 is heated to surpass the temperature set on the temperature controller 11 during baking, the temperature controller 11 snaps to cut off electricity to pause heating until the temperature drops down to a preset value. Then, the temperature controller 11 operates to turn on electricity to heat again. So, the temperature can be maintained evenly at the set value. In addition, the oil oozing out of the chicken will drop on the bottom of the baking pan 3.

Moreover, the switch 12 can be changed to the low-temperature line 122 so as to keep warming food in a low temperature (approximately between 65˜90° C.).

Or, the baking pan 3 can be replaced with the ceramic pan 4 for stewing foods. For that purpose, the switch 12 has to be changed to the low-temperature line 122 and the temperature controller 11 is set at a lower value (e.g. 75˜115° C.). Therefore, the present invention can be used to cook for different cuisines, more practical than conventional ovens.

While the preferred embodiment of the invention has been described above, it will be recognized and understood that various modifications may be made therein and the appended claims are intended to cover all such modifications that may fall within the spirit and scope of the invention.

What is claimed is:

1. An oven with two optional ranges of temperature, said oven comprising:
an outer body 1 provided with a temperature controller and a switch, said temperature controller connected with a power line, an electro thermal pad line at one side, a switch line at the other side and having a temperature knob on an exterior surface, said switch connected with said switch line of said temperature controller at one side and provided with a high-temperature line and a low-temperature line at the other side and a switching knob on an exterior surface;
an inner body fixed in said outer body and provided with an electro thermal pad wrapped around its exterior wall, said electro thermal pad connected with said electro thermal pad line of said temperature controller, said high-temperature line and said low-temperature line of said switch;
a baking pan put in said inner body and provided with a grip projecting from two sides respectively and a baking tray inside it;
a cover to be covered on said baking pan; and
said temperature controller and said switch able to be arranged with two options of temperature for high-temperature baking or low-temperature stewing.

2. The oven with two optional ranges of temperature as claimed in claim 1, wherein said outer body is provided with a grip at its two sides respectively.

3. The oven with two optional ranges of temperature as claimed in claim 1, wherein said electro thermal pad of said inner body is wrapped with a positioning member around its exterior wall, provided with an L-shaped connecting end at its two sides respectively for a screw to combine said two L-shaped connecting ends tightly together.

4. The oven with two optional ranges of temperature as claimed in claim 1, wherein said inner body is wrapped with a thermal isolator around its outer surface.

5. The oven with two optional ranges of temperature as claimed in claim 1, wherein said inner body is provided with a supporting edge on the top.

6. The oven with two optional ranges of temperature as claimed in claim 1, wherein said baking pan is provided with a covering rim on the top and an extended rim extending outwards around the top edge.

7. The oven with two optional ranges of temperature as claimed in claim 1, wherein said baking tray of said baking pan is provided with a holder at its two sides respectively.

8. The oven with two optional ranges of temperature as claimed in claim 1, wherein said oven is provided with a ceramic pan put in said inner body, provided with a grip projecting from its sides respectively for resting on said inner body.

9. The oven with two optional ranges of temperature as claimed in claim 8, wherein said ceramic pan is provided with a covering rim on the top and an extended rim extending outwards around the top edge.
